(19) United States
(12) Patent Application Publication
(10) Pub. No.: US 2019/0311355 A1
(43) Pub. Date: Oct. 10, 2019

(54) MODEL AND METHOD TO ADVANCED AUTHENTICATION AND AUTHORIZATION PROCESS FOR PAYMENT TRANSACTIONS IN A BANKING SYSTEM WITH NO CARDS ISSUED TO CUSTOMERS

(71) Applicant: CA, Inc., New York, NY (US)

(72) Inventors: Vijay Shashikant KULKARNI, Bangalore (IN); Vikrant NANDAKUMAR, Bangalore (IN); Lyju Rappai VADASSERY, Mumbai (IN); Goutama Sarma MYLAVARAPU, Bangalore (IN)

(21) Appl. No.: 15/948,591

(22) Filed: Apr. 9, 2018

(51) Int. Cl. G06Q 20/38; G06Q 20/40; G06Q 20/32

(52) U.S. Cl. CPC G06Q 20/385; G06Q 20/3223; G06Q 20/401; G06Q 20/382

(57) ABSTRACT

In accordance with the teachings of the present disclosure, devices and methods for authorizing a transaction may include steps of receiving a transaction initiation request from a user of a mobile application, generating a first encrypted code in response to receiving the transaction initiation request, and transmitting the first encrypted code to the mobile application. The steps also may include receiving a second encrypted code in response to transmission of the first encrypted code, determining whether the first encrypted code matches the second encrypted code. The steps may further include transmitting a one-time access code (OTAC), receiving a response to the OTAC, verifying the response to the OTAC, and authorizing the transaction in response to verifying the response to the OTAC. The steps may include receiving an acknowledgement message to apply to an account of the user for billing the transaction in response to authorizing the transaction.

### BACKGROUND

The present disclosure relates to devices and methods for providing advanced authentication and authorization techniques for payment transactions in stores and online that do not require an issued debit or credit card.

Credit and debit cards are commonly used for making purchases or any other kind of payment in stores and online. Such credit and debit cards are prone to mis-use in certain scenarios. For example, issuing physical credit and debit cards has led to problems of card loss, card skimming, and other card-based frauds. Banks often incur costs and fraud risks related to maintenance of the cards. Additionally, the processes involved are often implemented in a cumbersome way and online transactions are often processed using the industry standard 3-D secure protocol. When a user makes an online or in-store purchase, the user presents checkout details, including credit/debit card details (e.g., card number, expiration date, CVV number), card holder name (for online purchases), swiping the debit/credit card (for in-store purchases), and keying in a transaction pin (Txn pin) for in-store check-outs using a debit card. The purchase is routed to perform a card holder authentication process where one-time password (OTP)-based or other similar sophisticated authentication procedures are run based on the risk profile of the card holder or the card. Once authentication is completed, an authorization process validates and approves the transaction amount and its payment to the merchant.

There are solutions to work around wallet concepts and pre-approved amount code, such as Unified Payments Interface (UPI) and Google's payment app, Tez. Existing methods of payment transaction processing need a set of processes/programs to be run for every transaction carried out online or in-store. However, existing in-app payment options do not cater to two-factor authentication and a 3-D Secure payment solution necessitates a credit or debit card number for the transaction.

### BRIEF SUMMARY

According to an aspect of the present disclosure, a method may include steps of: receiving an encrypted code from a mobile device participating in a transaction through a mobile application registered with a bank; decoding the encrypted code; determining whether the decoded encrypted code has been validated by the bank; receiving a one-time access code, triggered by the bank in response to validation of the decoded encrypted code, from the mobile device; authenticating the one-time access code; and processing the transaction in response to authentication of the one-time access code.

According to another aspect of the present disclosure, a non-transitory, computer-readable storage medium may include instructions that when executed by a computer, cause the computer to perform a method including steps of: receiving an encrypted code from a mobile device participating in a transaction through a mobile application registered with a bank; decoding the encrypted code; determining whether the decoded encrypted code has been validated by the bank; receiving a one-time access code, initiated by the bank in response to validation of the decoded encrypted code, from the mobile device; authenticating the one-time access code; and processing the transaction in response to authentication of the one-time access code.

According to another aspect of the present disclosure, a system may include a processor configured to execute program instructions to: receive an encrypted code from a mobile device participating in a transaction through a mobile application registered with a bank; decode the encrypted code; determine whether the decoded encrypted code has been validated by the bank; receive a one-time access code, initiated by the bank in response to validation of the decoded encrypted code, from the mobile device; authenticate the one-time access code; and process the transaction in response to authentication of the one-time access code.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a diagram of a system, in accordance with the teachings of the present disclosure.

FIG. 2 illustrates a flow chart depicting a method, in accordance with the teachings of the present disclosure.

FIG. 3 illustrates a process of authenticating and authorizing a transaction without using a credit or debit card in accordance with a non-limiting embodiment of the present disclosure.

FIG. 4A illustrates an environment for authenticating and authorizing a transaction without using a credit or debit card according to a non-limiting embodiment of the present disclosure.

FIG. 4B illustrates a server for authenticating and authorizing a transaction without using a credit or debit card according to a non-limiting embodiment of the present disclosure.

FIG. 4C illustrates a mobile computing device according to a non-limiting embodiment of the present disclosure.

FIG. 5 illustrates a flow chart depicting a method, in accordance with the teachings of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to a broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

In view of the foregoing, a need has arisen for ways to authenticate and authorize purchases without requiring use of a credit or debit card or card number, and in a way that provides additional security, such as utilizing two-factor authentication.

Devices and methods disclosed herein may provide a way to avoid the usage of debit and credit cards to make an online or in-store purchase or payment by initiating a transaction code from a merchant and pushing that code to a user, who may be using a mobile device having a mobile banking app. The transaction code may be uploaded to the mobile banking app. A bank may issue a crypto message and push it to the user's mobile device after successfully performing authentication/authorization. The crypto message may be uploaded to the merchant website for decryption and processing for payment clearance.

This technique may require a mobile app registered with a bank or other financial institution (e.g., a Chase credit card account or Bank of America checking/savings account mobile app), a cryptographic message transfer protocol, a mechanism to read or input the cryptographic code to a merchant website, merchant software having public/private keys to process the messages, a device to input/receive cryptographic code and two-factor authentication inputs by customer for in-store purchases, and any standard two-factor authentication mechanism for validation with a customer.

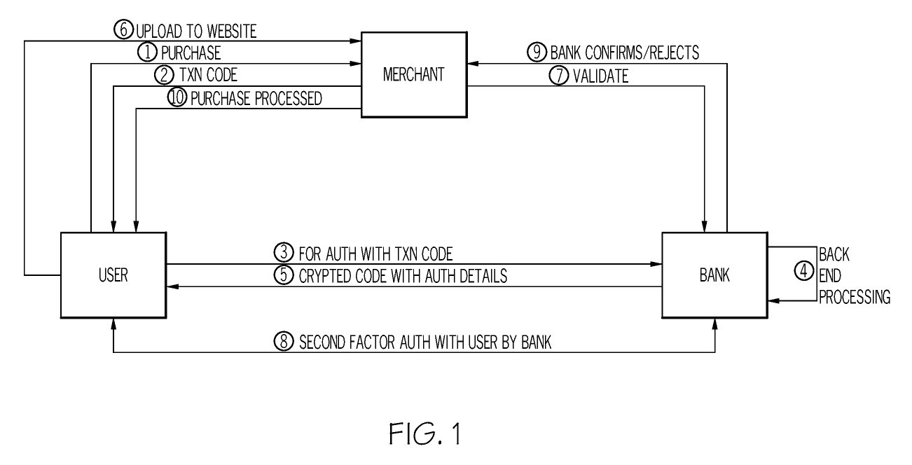

FIG. 1 depicts an example process 100 for an online purchase from input to output according to the present invention. At step 1, a request to make a purchase may be initiated from a mobile app. This mobile app may be registered with a bank or other financial institution on a merchant website for which a transaction code (Txn code) is generated. That Txn code may then be pushed to the mobile app as a message (step 2). A user may upload this received Txn code into the bank's mobile app while requesting authentication/authorization for a purchase or payment (step 3). The authentication/authorization may then be approved or rejected by the bank via back-end processing (step 4). As part of this approval or rejection, the bank may issue an encrypted code via a QR code, a bar code, a hash value, or any other suitable cryptic format (step 5). The message from the bank containing the encrypted code may include details required to complete the transaction. The message from the bank containing the encrypted code may be time-bound. For example, the message containing the encrypted code may only be accessible for a period of 5 minutes. The user may then upload this encrypted code to the merchant website from the mobile app (step 6). The merchant may then decrypt the code and validate the transaction with the bank (step 7). The bank may cross-validate this request from the merchant with the customer via SMS message, e-mail, interactive voice response (IVRS), or any other suitable communication mechanism (step 8), and then may approve or reject the merchant's request (step 9). This represents a two-factor authentication process. The merchant may then process the transaction based on the bank's approval and may provide an update back to the bank for reconciliation purposes (step 10).

The above-described mechanism of transaction code creation may remain the same for purchases from a merchant website via a mobile device or other browser-based transaction (e.g., from a desktop or laptop computer). For other browser-based transactions, the Txn code may still be received on the mobile device by providing the customer's mobile phone number on the merchant website. The message pushed by the merchant website may have a URL link to click and enable the user to provide the encrypted code received from the bank.

The above-described transaction process may be similar for in-store transactions. For an in-store transaction, a point-of-sale (POS) system may initiate the Txn code, accept an input of the user's mobile phone number, and push the code to the customer's mobile phone number. The message pushed by the merchant POS system may also have a URL link to click and enable the user to provide the encrypted code received from the bank.

According to an embodiment of the invention, an online purchase may be authorized and processed without using a debit/credit card or card number. A customer wishing to conduct an online transaction may initiate a pre-authentication and authorization of his account via a mobile push request to an issuer bank or issuer bank software. The customer may send this push request from the customer's mobile phone via the issuer bank's mobile application. The issuer bank may receive this request and generate a message including a code that may be delivered to the customer's mobile device app. The code may be a QR code, a bar code, a unique hash value, an encoded alphanumeric code (e.g., 15 to 20 characters), or any other suitable encryption code. The code delivered to the mobile device app may also be time bound, i.e., the code will expire after a pre-determined period of time, e.g., after 5 minutes. The message may also contain transaction details, such as customer id, bank id, customer authentication result, authorization details, and spend limit details. The customer may then use the code as payment authorization and a submission request to the merchant website (e.g., the customer may upload to the merchant website).

The merchant software may initiate decryption of the code and verification of the code's authenticity by pinging the corresponding issuer bank. The issuer bank may then approve the request to the merchant. This may trigger sending a One Time Access Code (OTAC) to the customer. Upon receiving the OTAC, the customer may input the code on a merchant software request screen (i.e., a website). The bank may then verify the OTAC from the merchant software, and if verified, the payment may be processed successfully. Upon successful processing, the merchant may charge the issuer bank the exact amount, which is sent back to the issuer bank in an acknowledgement message to apply on the customer's account for billing. In another example embodiment, the second factor authentication may occur between the bank backend and the customer. The bank may trigger the OTAC to the user's mobile and the user may confirm the request back via inputting the code on the banking application. Upon successful (or unsuccessful) validation by the banking application, a confirmation (or rejection) message may be posted back to the merchant website by the bank.

As part of this authentication and authorization process, the merchant software may utilize the transaction details contained in the message from the bank. For example, the merchant software may determine whether an amount of the purchase is within the authorized spend limits of the user based on the spent limit details included in the message. For example, the message from the bank could define a spend limit of an amount per purchase from a particular merchant (e.g., $500 from one store), a total amount permitted to be spent within a particular time period (e.g., $1000 per day), or any other suitable spend limit. In an embodiment where the encrypted code is time bound, the merchant may also determine whether the time period for accessing the encrypted code has expired or whether it is still within the time bound limits, and thus whether the encrypted code remains accessible for the merchant to use in authenticating and authorizing the transaction. The encrypted code may remain accessible if the period of time defined by the bank has not yet expired (e.g., if the encrypted code has a time period of 5 minutes, the code remains accessible for use in authenticating and authorizing a transaction within that 5 minute period).

In one example, the code received from the bank may be a QR code. The QR code may be provided to the merchant software in any suitable manner. In one example embodiment, the QR code is scanned using a device, such as a webcam, the camera on the user's mobile device (if one is provided), or any other suitable device. The message or image generated by the issuer bank and sent to the customer's mobile may also be scanned or have a picture taken by the merchant website, which may then be decoded and processed as a payment request, as described above. The code received from the bank may be interfaced or provided to the merchant software via the same banking application. Any sophisticated methods of QR code scanning may be employed by the merchant for online purchases. Various methods exist to generate QR and other encrypted codes and these may be leveraged into mobile banking apps.

The customer may be accessing the merchant's website using a laptop or desktop computer rather than via a mobile phone. However, the customer still uses the mobile phone and mobile banking app to initiate the transaction.

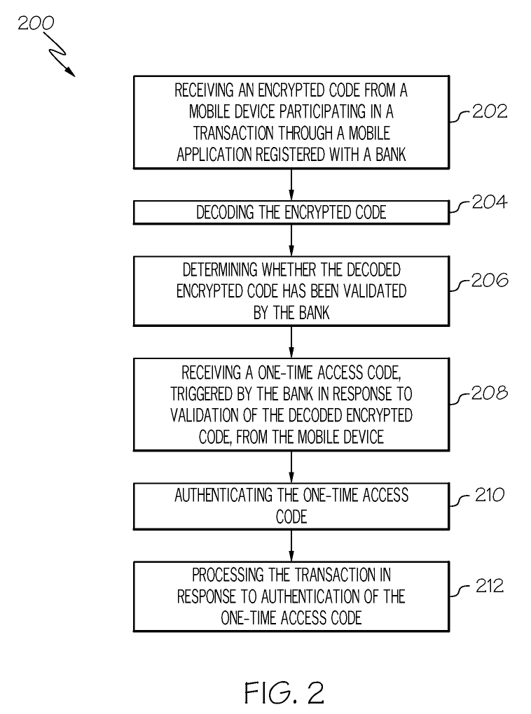

FIG. 2 illustrates a method 200 of a merchant authorizing a transaction without using a debit or credit card according to an embodiment of the present invention. At step 202, an encrypted code is received from a mobile device participating in a transaction through a mobile application registered with a bank. The encrypted code is decoded at step 204. At step 206, it is determined whether the decoded encrypted code has been validated by the bank. A one-time access code (OTAC) is received from the mobile device at step 208. The OTAC is triggered by the bank in response to validation of the decoded encrypted code. At step 210, the OTAC is authenticated. The transaction is processed in response to authentication of the OTAC at step 212.

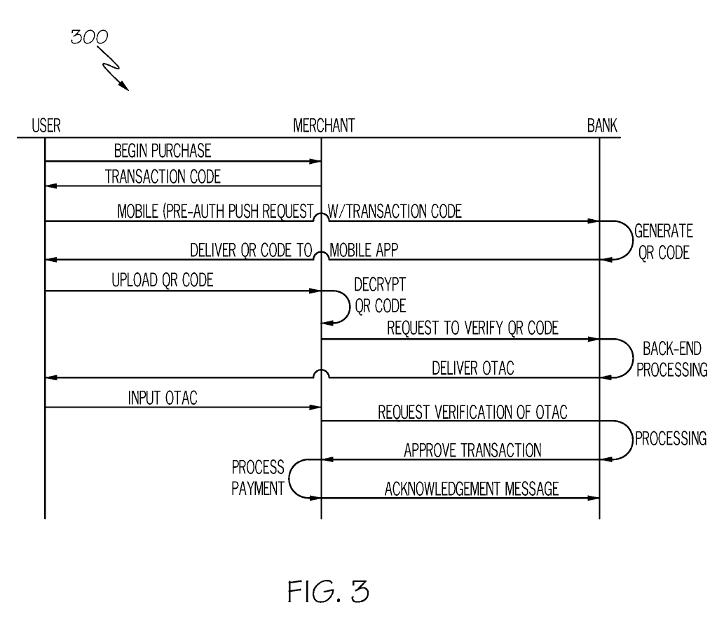

According to an embodiment of the invention depicted in FIG. 3, a user or customer wishes to begin making a purchase online from a merchant. The user may then receive a transaction code from the merchant. The user may initiate pre-authorization of the purchase by sending a push request via a mobile app. The mobile app may be an app corresponding to the user's bank or credit card account. The transaction code may be provided to the user's bank for authentication with the mobile push request. The bank may perform back end processing to determine whether to authenticate the transaction or not. If the bank verifies the authenticity of the transaction code, the bank generates a QR code containing authentication details that may be delivered to the user's mobile application. The QR code is merely an example and the bank may generate any suitable encrypted code. The user uploads the QR code to the merchant's website. The merchant decrypts the QR code and provides it to the bank for validation. As part of the validation process, the bank performs a second factor authentication with the user via SMS, e-mail, IVRS, or other suitable communication mechanism. In the embodiment of FIG. 3, the request to verify the QR code triggers the bank to generate a one-time access code (OTAC) that is delivered to the user. The user may input the OTAC into the merchant website, which may then request verification of the OTAC from the bank. The bank then confirms or rejects the transaction to the merchant depending on the outcome of the second factor authentication. If the second factor authentication is successful, the bank confirms the transaction. Upon receiving the confirmation, the merchant processes the purchase for the user. The merchant may also send an acknowledgement message to the bank containing the details of the transaction including the price, so the bank may bill the customer.

The communications between the merchant and the bank may be processed by a third or middle party through similar mechanisms as to how a middle party currently processes credit card transactions which occur by swiping a physical card or entering card information on a website. In order to process communications between the user's mobile app and the merchant website, particularly involving the QR or other encrypted code, a software module may be added to the banking mobile app and the merchant website may be enhanced in order to be able to process the codes.

Further, various methods exist in the market to generate QR codes and other encrypted codes. Any of these methods may be leveraged into the banking mobile app in order to generate the QR or other encrypted code, depending on the preferences of the bank.

According to an embodiment of the present invention, an in-store purchase may be authorized without using a debit/credit card or card number. A customer may initiate pre-authentication and authorization of his or her account via a mobile push request to the issuer bank or issuer bank software at the point-of-sale (POS) while checking out. The customer may use a mobile phone to send this push request via the issuer bank's mobile application. The issuer bank may receive the request from the customer and generate a message including a code that may be delivered to the customer's mobile device app for the issuer bank. The code may be a QR code, a bar code, a unique hash value, an encoded alphanumeric code (e.g., 15 to 20 characters), or any other suitable encryption code. The code delivered to the mobile device app may also be time bound, i.e., the code will expire after a pre-determined period of time, e.g., after 5 minutes. The message may also contain transaction details, such as customer id, bank id, customer authentication result, authorization details, and spend limit details. The customer may then use the code as payment authorization and a submission request to the merchant.

In the example of an in-store purchase, the merchant may have a device at the POS to scan the code from the customer's mobile app. The device may be any suitable hardware device that is capable of scanning QR codes, bar codes, or other types of encrypted codes. The merchant may then initiate decryption of the code and verification of the code's authenticity by pinging the corresponding issuer bank. The bank may then approve the request to the merchant by validating the code the bank received by the merchant as the code the bank had previously sent to the customer's mobile app. The bank may then trigger sending a One Time Access Code (OTAC) to the customer. Upon receiving the OTAC, the customer may input the OTAC on a merchant software request screen of the POS device. The bank may then verify the OTAC after receiving it from the merchant software, and if verified, payment may be successfully processed. Upon successful processing, the merchant may charge the issuer bank the exact amount, which is sent back to the issuer bank in an acknowledgement message to apply on the customer's account for billing. In another example embodiment, the second factor authentication may occur between the bank backend and the customer. The bank may trigger the OTAC to the user's mobile and the user may confirm the request back via inputting the code on the banking application. Upon successful (or unsuccessful) validation by the banking application, a confirmation (or rejection) message may be posted back to the merchant website by the bank.

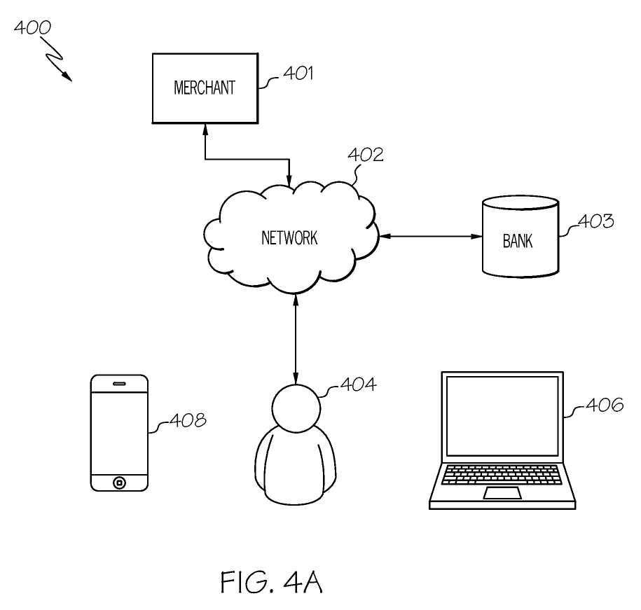

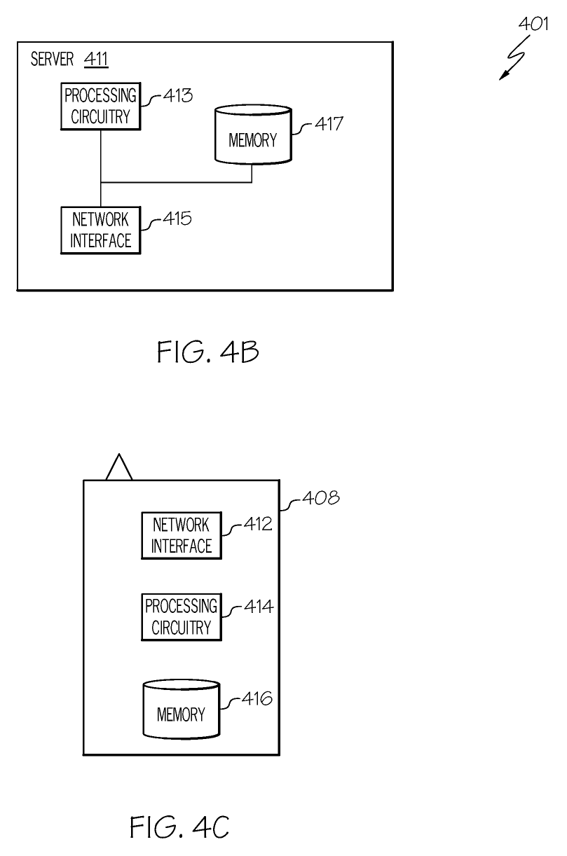

FIG. 4A illustrates an exemplary distributed system 400 in which the subject matter of the disclosure can function. The system 400 generally includes a public network 402 communicatively coupling a merchant 401, a bank 403, and one or more client devices 406, 408. In the depicted embodiment, for example, system 400 includes a user 404 of one or more computing devices 406, 408. A user 404 may be a primary card or account holder of a financial account maintained by bank 403. As described above, according to certain embodiments, user 404 may download a mobile payment application to one or more computing devices 406, 408 associated with user 404 that is registered with the user's credit or debit card information. The mobile payment application may then be used by the user 404 to complete financial transactions, such as purchases from the merchant 401 that are authorized by the bank 403.

The network 402 generally refers to any interconnecting system capable of transmitting audio, video, signals, data, messages, or any combination of the preceding. Further, the network 402 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems.

Computing devices 406, 408 may communicate with merchant 401 and/or bank 403 via network 402, which may include any number of subnetworks. In the depicted embodiment, computing device 406 is a laptop computer and computing device 408 is a mobile phone (i.e., smartphone). Network 402 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol, such as Internet Protocol (IP), may be used to communicate the packet flows.

A packet flow may be identified in any suitable manner. As an example, a packet flow may be identified by a packet identifier giving the source and destination of the packet flow. A source may be given by an address, such as the IP address, port, or both. Similarly, a destination may be given by an address, such as the IP address, port, or both.

According to certain embodiments, network 402 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third generation partnership project (3GPP) standards, or other standards.

As used here, the term “computing device” and “wireless device” generally refers to any suitable device operable to communicate with the merchant 401 and/or bank 403 through the network 402. Computing devices 406, 408 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the merchant 401 and/or bank 403 through the network 402. Further, computing devices 406, 408 may employ any known operating systems such as MSDOS®, PC-DOS®, OS-2®, MAC-OS®, or any other appropriate operating systems.

In particular embodiments of the invention, communications between computing devices 406, 408 and merchant 401 and bank 403 may be effected according to one or more secure wireless communication protocols or WLAN protocols, such as portions or all of the Wired Equivalent Privacy (WEP) protocol, the Robust Security Network (RSN) associated with the IEEE 802.11 protocol, the IEEE 802.1x protocol, the Advanced Encryption Standard (AED), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shred key (WPA2-PSK) protocol, for example.

FIG. 4B illustrates a merchant 401 according to a non-limiting embodiment. As depicted, merchant 401 includes server 411, which includes a processing circuitry 413, a network interface 415, and a system memory 417. The network interface 415 connects server 411 to network 402. The processing circuitry 413 may be utilized for the processing requirements of server 411. In certain embodiments, processing circuitry 413 may be operable to load instructions from a hard disk into memory 417 and execute those instructions.

Network interface 415 may refer to any suitable device capable of receiving an input, sending an output from server 411, performing suitable processing of the input or output or both, communicating with other devices, and so on. For example, the network interface 415 may include appropriate modem hardware, network interface card, and similar devices. Further, the software capabilities of the network interface 415 may include protocol conversion and data processing capabilities, to communicate through a LAN, WAN, or other communication system, allowing server 411 to communicate to other devices. Moreover, the network interface 415 may include one or more ports, conversion software, or both.

Processing circuitry 413 can be any suitable device capable of executing instructions to perform operations for server 411. Processing circuitry 413 may include microprocessors, microcomputers, microcontrollers, digital signal processors, central processing units, processing circuitry, state machines, logic circuitries, and/or any devices that manipulate signals based on operational instructions. For example, processing circuitry 413 may be any central processing unit (CPU), such as the Pentium processor, the Intel Centrino processor, and so on.

Further, the system memory 417 may be any suitable device capable of storing computer-readable data and instructions. For example, the system memory 417 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 417 stores account information, which may include any data generated or received for the completion of financial transactions by computing devices 406, 408. For example, memory 417 may be used to store transaction related information associated with an account. In one example, transaction information may include a list of transactions that have been authorized or denied. Such information may also include merchant identification information, location information, date information, amount information, requesting user information, or other suitable transaction-specific information, according to certain embodiments.

Although server 411 is depicted as including only a single network interface 415, processing circuitry 413, and memory 417, these items may be present in multiple items, or combined items, as known in the art. It is also recognized that other embodiments may include the placement of one or more of these components elsewhere in server 411.

The bank 403 may similarly include a server, processing circuity, network interface, and memory, as illustrated in FIG. 4B. The memory of bank 403 may be configured to store the user's account information may include credit or debit card information including account number, expiration dates, security codes, spend limits and other suitable information. According to certain embodiments, server of bank 403 may provide mobile payment application for provisioning on computing devices 406, 408. For example and as described above, when setting up the mobile payment application on a computing device 406, 408, user 404 may first register a credit or debit card for use with the mobile payment application. According to certain embodiments, registering the credit or debit card may include entering the credit or debit card account number, expiration date, security code, and any other information associated with the credit or debit card. The server of bank 403 may also generate encrypted codes, as described above, and transmit them to computing device 406, 408 via the bank 403's network interface.

As discussed above, to authenticate and authorize a payment transaction, server of the bank 403 may send an encrypted code to the computing device 406, 408 on which the credit or debit card is being registered. For example, if user 404 downloads the mobile banking application to mobile phone 408, server of the bank 403 sends an encrypted code to mobile phone 408. The mobile banking application may then request that user 404 upload the encrypted code to server 411 of merchant 401 to authenticate user 404 and authorize the payment transaction. Similarly, the server of the bank 403 sends a one-time access code (OTAC) to mobile banking application on mobile phone 408. The mobile banking application may then request that user 404 enter the OTAC and send to server 411 of merchant 401 to authenticate user 404 and authorize the payment transaction.

FIG. 4C illustrates a mobile computing device 408 according to a non-limiting embodiment. As depicted, the mobile computing device includes a processing circuity 414, a network interface 412, and a memory 416. The network interface 412 connects the mobile computing device 408 to the network 402. The processing circuity 414 may be utilized for the processing requirements of mobile computing device 408. In certain embodiments, processing circuity 414 may be operable to load instructions from a hard disk into memory 416 and execute those instructions. Network interface 412 may refer to any suitable device capable of receiving an input, sending an output, performing suitable processing of the input or output or both, communicating with other devices, and so on. For example, the network interface 412 may include appropriate modem hardware, network interface card, and similar devices. Further, the software capabilities of the network interface 412 may include protocol conversion and data processing capabilities, to communicate through a LAN, WAN or other communication system, allowing mobile computing device 408 to communicate to other devices. Moreover, the network interface 412 may include one or more ports, conversion software, or both.

Processing circuity 414 can include any suitable device capable of executing instructions to perform operations for the mobile computing device. Processing circuitry 414 may include microprocessors, microcomputers, microcontrollers, digital signal processors, central processing units, processing circuitry, state machines, logic circuitries, and/or any devices that manipulate signals based on operational instructions. For example, processing circuitry 414 may be any central processing unit (CPU), such as the Pentium processor, the Intel Centrino processor, and so on.

Further, the system memory 416 may be any suitable device capable of storing computer-readable data and instructions. For example, the system memory 416 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 416 stores a mobile banking application for conducting a purchase transaction associated with a bank or credit card account. Additionally, memory 416 may store any data generated or received for the completion of the purchase transaction by the merchant 401 or the bank 403, such as an encrypted code or one-time access code (OTAC).

Although the mobile computing device depicted in FIG. 4C is shown as including only a single network interface 412, processing circuitry 414, and memory 416, these items may be present in multiple items, or combined items, as known in the art. It is also recognized that other embodiments may include the placement of one or more of these components elsewhere in the mobile computing device.

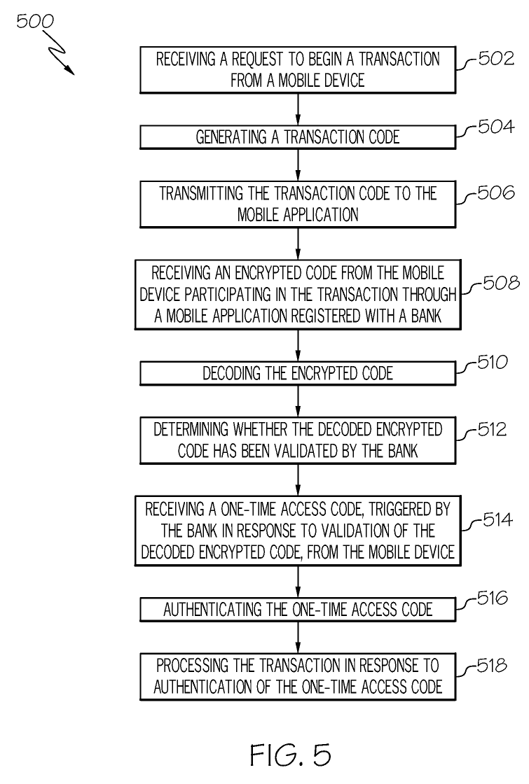

FIG. 5 illustrates a method 500 of a merchant authorizing a transaction without using a debit or credit card according to an embodiment of the present invention. At step 502, a request to begin a transaction is received from a mobile device. A transaction code is generated at step 504. At step 506, the transaction code is transmitted to a mobile application of the mobile device. The mobile device is participating in the transaction through the mobile application that is registered with a bank. An encrypted code is received from the mobile device at step 508. At step 510, the encrypted code is decoded. It is determined whether the decoded encrypted code has been validated by the bank at step 512. A one-time access code (OTAC) is received from the mobile device at step 514. The OTAC is triggered by the bank in response to validation of the decoded encrypted code. At step 516, the OTAC is authenticated. The transaction is processed in response to authentication of the OTAC at step 518.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
receiving a transaction initiation request from a user of a mobile application;
generating a first encrypted code in response to receiving the transaction initiation request;
transmitting the first encrypted code to the mobile application;
receiving a second encrypted code in response to transmission of the first encrypted code;
determining whether the first encrypted code matches the second encrypted code;
transmitting a one-time access code in response to determining that the first encrypted code matches the second encrypted code;
receiving a response to the one-time access code;
verifying the response to the one-time access code;
authorizing the transaction in response to verifying the response to the one-time access code; and
receiving an acknowledgement message to apply to an account of the user for billing the transaction in response to authorizing the transaction.

2. The method of claim 1, wherein the first encrypted code comprises an image generated by a bank registered with the mobile application.

3. The method of claim 2, wherein the image comprises one of a QR code, a bar code, a unique has value, or an encoded alphanumeric code.

4. The method of claim 1, wherein the first encrypted code comprises a customer ID, a bank ID, and spend limit details for a user registered with the mobile application.

5. The method of claim 1, wherein the transaction initiation request comprises a transaction code generated by a merchant.

6. The method of claim 1, wherein the second encrypted code is received from a merchant and wherein the second encrypted code is based on initiating decryption of the first encrypted code.

7. The method of claim 1, wherein generating the first encrypted code further comprises:
determining a time limit for accessing the first encrypted code; and
determining an authorized spend limit for using the first encrypted code.

8. A non-transitory, computer-readable storage medium comprising instructions that when executed by a computer, cause the computer to perform a method comprising:
receiving a transaction initiation request from a user of a mobile application;
generating a first encrypted code in response to receiving the transaction initiation request;
transmitting the first encrypted code to the mobile application;
receiving a second encrypted code in response to transmission of the first encrypted code;
determining whether the first encrypted code matches the second encrypted code;
transmitting a one-time access code in response to determining that the first encrypted code matches the second encrypted code;
receiving a response to the one-time access code;
verifying the response to the one-time access code;
authorizing the transaction in response to verifying the response to the one-time access code; and
receiving an acknowledgement message to apply to an account of the user for billing the transaction in response to authorizing the transaction.

9. The non-transitory, computer-readable storage medium of claim 8, wherein the first encrypted code comprises an image generated by a bank registered with the mobile application.

10. The non-transitory, computer-readable storage medium of claim 9, wherein the image comprises one of a QR code, a bar code, a unique has value, or an encoded alphanumeric code.

11. The non-transitory, computer-readable storage medium of claim 8, wherein the first encrypted code comprises a customer ID, a bank ID, and spend limit details for a user registered with the mobile application.

12. The non-transitory, computer-readable storage medium of claim 8, wherein the transaction initiation request comprises a transaction code generated by a merchant.

13. The non-transitory, computer-readable storage medium of claim 8, wherein the second encrypted code is received from a merchant and wherein the second encrypted code is based on initiating decryption of the first encrypted code.

14. The non-transitory, computer-readable storage medium of claim 8, wherein generating the first encrypted code further comprises:
determining a time limit for accessing the first encrypted code; and
determining an authorized spend limit for using the first encrypted code.

15. A system comprising:
a processor configured to execute program instructions to:
receive a transaction initiation request from a user of a mobile application;
generate a first encrypted code in response to receiving the transaction initiation request;
transmit the first encrypted code to the mobile application;
receive a second encrypted code in response to transmission of the first encrypted code;
determine whether the first encrypted code matches the second encrypted code;
transmit a one-time access code in response to determining that the first encrypted code matches the second encrypted code;
receive a response to the one-time access code;
verify the response to the one-time access code;
authorize the transaction in response to verifying the response to the one-time access code; and
receive an acknowledgement message to apply to an account of the user for billing the transaction in response to authorizing the transaction.

16. The system of claim 15, wherein the first encrypted code comprises an image generated by a bank registered with the mobile application.

17. The system of claim 16, wherein the image comprises one of a QR code, a bar code, a unique has value, or an encoded alphanumeric code.

18. The system of claim 15, wherein the transaction initiation request comprises a transaction code generated by a merchant.

19. The system of claim 15, wherein the second encrypted code is received from a merchant and wherein the second encrypted code is based on initiating decryption of the first encrypted code.

20. The system of claim 15, wherein generating the first encrypted code further comprises:
determining a time limit for accessing the first encrypted code; and
determining an authorized spend limit for using the first encrypted code.
